(19) United States
(12) Patent Application Publication
(10) Pub. No.: US 2022/0317681 A1
(43) Pub. Date: Oct. 6, 2022

(54) TRANSPORT CONTROL METHOD, TRANSPORT APPARATUS, AND TRANSPORT CONTROL SYSTEM

(71) Applicant: NEC Corporation, Minato-ku, Tokyo (JP)

(72) Inventors: Takayuki SUZUKI, Tokyo (JP); Hiroshi YOSHIDA, Tokyo (JP); Akihito KOHIGA, Tokyo (JP)

(73) Assignee: NEC Corporation, Minato-ku, Tokyo (JP)

(21) Appl. No.: 17/640,958

(22) PCT Filed: Aug. 31, 2020
(86) PCT No.: PCT/JP2020/032913

§ 371 Date: Mar. 7, 2022

(30) Foreign Application Priority Data
Sep. 30, 2020 (JP) 2019-179041

(51) Int. Cl. G05D 1/00; G05D 1/10; B64C 39/02

(52) U.S. Cl. CPC G05D 1/0022; G05D 1/104; B64C 39/024; B64C 2201/128; B64C 2201/146

(57) ABSTRACT

There is provided a transport control method including receiving, from a control apparatus, first control information for transporting an object; and transmitting, from a first transport apparatus to a second transport apparatus, second control information for the first transport apparatus and the second transport apparatus to cooperate to transport the object according to the first control information.

### BACKGROUND

### Technical Field

The present invention relates to a transport control method, a transport apparatus, and a transport control system that control transport of an object using a plurality of transport apparatuses.

### Background Art

For example, for transport of goods and the like, a transport apparatus such as an unmanned transport vehicle and a drone has been generally used. When transporting goods using such a transport apparatus, for example, a control command is transmitted from a control apparatus to the transport apparatus by means of radio communication. The transport apparatus causes a motor and the like to operate in accordance with the received control command, and thereby performs transport of the goods.

Further, there is a limit on the weight of goods that can be transported by a single transport apparatus, and thus there is a problem in that stable transport cannot be performed. In order to address such a problem, for example, a technique in which a plurality of transport apparatuses cooperate to transport goods has been under study.

For example, PTL 1 discloses the following: in a robot system in which an operation instruction is transmitted from a master robot to a slave robot, control is executed by causing a delay of a predetermined time in order that the master robot synchronizes with control time of the slave robot.

Further, PTL 2 discloses the following: when a target to be controlled is remotely controlled via a communication network, a communication delay in the communication network is measured and control is performed by taking the delay amount into consideration, a delay time is calculated by using time from when a message is transmitted to when a response is received, and an overshoot amount due to the delay is predicted, a target value is modified, and then a control signal is transmitted to the target to be controlled.

### CITATION LIST

### Patent Literature

[PTL 1] JP 2003-145462 A
[PTL 2] JP 2018-107568 A

### SUMMARY

### Technical Problem

However, in the technique described in PTL 1, a delay time for control is time determined in advance, and thus if a positional relationship is liable to vary among transport apparatuses that cooperate to transport an object, the delay time is liable to vary as well, which makes it difficult to establish synchronization of control time between the master robot and the slave robot.

Further, in the technique described in PTL 2, no consideration is given to collective monitoring of operations of a plurality of transport apparatuses, and thus the plurality of transport apparatuses that transport an object do not operate in cooperation with each other.

One example of the present invention is directed to provide a transport control method, a transport apparatus, and a transport control system that enable appropriately cooperated operation between a plurality of transport apparatuses when transporting an object using the plurality of transport apparatuses.

### Solution to Problem

According to one example aspect of the present invention, a transport control method includes: receiving, from a control apparatus, first control information for transporting an object; and transmitting, from a first transport apparatus to a second transport apparatus, second control information for the first transport apparatus and the second transport apparatus to cooperate to transport the object according to the first control information.

According to one example aspect of the present invention, a transport apparatus is a first transport apparatus including: a reception processing section configured to receive, from a control apparatus, first control information for transporting an object; and a transmission processing section configured to transmit, to a second transport apparatus, second control information for cooperating with the second transport apparatus to transport the object according to the first control information.

According to one example aspect of the present invention, a transport control system includes: a first transmission processing section configured to transmit first control information for transporting an object to a first transport apparatus; and a second transmission processing section configured to transmit, from the first transport apparatus to a second transport apparatus, second control information for cooperating with the second transport apparatus to transport the object according to the first control information.

### Advantageous Effects of Invention

According to one example aspect of the present invention, appropriately cooperated operation between transport apparatuses can be enabled when transporting an object using a plurality of transport apparatuses. Note that, according to the present invention, instead of or together with the above effects, other effects may be exerted.

### BRIEF DESCRIPTION OF THE DRAWINGS

FIG. 1 is an explanatory diagram illustrating an example of a schematic configuration of a transport control system 1 according to a first example embodiment;

FIG. 2 is a block diagram illustrating an example of a hardware configuration of a control apparatus 100 according to the first example embodiment;

FIG. 3 is a block diagram illustrating an example of a functional configuration of the control apparatus 100 according to the first example embodiment;

FIG. 4 is a block diagram illustrating an example of a hardware configuration of a transport apparatus 200 according to the first example embodiment;

FIG. 5 is a block diagram illustrating an example of a functional configuration of the transport apparatus 200 according to the first example embodiment;

FIG. 6 is a flowchart illustrating a flow of processing performed by the control apparatus 100;

FIG. 7 is a flowchart illustrating a flow of processing performed by a master transport apparatus;

FIG. 8 is a flowchart illustrating a flow of processing performed by a slave transport apparatus;

FIG. 9 is an explanatory diagram illustrating an example of a schematic configuration of a transport control system 2 according to a second example embodiment;

FIG. 10 is a flowchart illustrating a flow of processing performed by the master transport apparatus;

FIG. 11 is a flowchart illustrating a flow of processing performed by the slave transport apparatus;

FIG. 12 is an explanatory diagram illustrating an example of a schematic configuration of a transport control system 3 according to a third example embodiment; and

FIG. 13 is a diagram for describing a flow of processing performed by the transport control system 3 according to the third example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.

1. Overview of Example Embodiments of Present Invention

2. First Example Embodiment
2.1. Configuration of Transport Control System 1
2.2. Configuration of Control Apparatus 100
2.3. Configuration of Transport Apparatus 200
2.4. Operation Examples

3. Second Example Embodiment
3.1. Configuration of Transport Control System 2
3.2. Operation Examples

4. Third Example Embodiment
4.1. Configuration of Transport Control System 3
4.2. Operation Examples

5. Other Example Embodiments

### 1. OVERVIEW OF EXAMPLE EMBODIMENTS OF PRESENT INVENTION

First, an overview of example embodiments of the present invention will be described.

### (1) Technical Issues

For example, for transport of goods and the like, a transport apparatus such as an unmanned transport vehicle and a drone has been generally used. When transporting goods using such a transport apparatus, for example, a control command is transmitted from a control apparatus to the transport apparatus by means of radio communication. The transport apparatus causes a motor and the like to operate in accordance with the received control command, and thereby performs transport of the goods.

Further, there is a limit on the weight of goods that can be transported by a single transport apparatus, and thus there is a problem in that stable transport cannot be performed. In order to address such a problem, for example, a technique in which a plurality of transport apparatuses cooperate to transport goods has been under study.

In a case in which a plurality of transport apparatuses cooperate to transport goods, when each of the transport apparatuses starts moving at their own timings, a distance, a direction, and the like between the transport apparatuses and a transported object may be changed. For example, when unmanned aircrafts such as drones are used as the transport apparatuses, the unmanned aircrafts may drop goods. For this reason, the timings at which a plurality of transport apparatuses start moving need to be synchronized with each other with high accuracy.

However, in radio communication, arrival delay of data packets and delay variation (delay jitter) of packet arrival occur due to radio wave strength, radio wave interference, or noise in radio communication, other communication traffic, or the like. In remote control of radio communication, control performance (for example, stability, a transient response, or the like) may be deteriorated due to the influence of packet arrival delay and delay jitter of packet arrival described above. In particular, in a control system, it is difficult to implement high control performance when delay jitter, rather than the delay itself, is large.

In order to address such a problem, for example, a method in which operation start timings of robots are synchronized with each other by transmitting a control command provided with information of operation start time to each of the robots is considered. The method presupposes that the control apparatus and each of the robots are synchronized with each other regarding time with high accuracy; however, clocks do not exactly match each other in each of the robots, and pieces of time information of different apparatuses thus cannot be used together.

Further, as a method of causing synchronization of operation start timings of the transport apparatuses without depending on time synchronization, the following method is considered. In the method, the control apparatus predicts delay time due to communication with each of the transport apparatuses, and the transport apparatuses perform their operations so as to be synchronized with the timing at which one of the transport apparatuses having the longest delay time starts its operation. In this manner, the operation start timings of the plurality of transport apparatuses can be synchronized with each other. The delay time is, for example, predicted by using time series data of acknowledgement (ACK) packets returned from a target transport apparatus.

In general, when a distance of radio communication is large, radio signal power of the control command transmitted from the control apparatus to the transport apparatus is significantly reduced due to distance attenuation and attenuation caused by an obstruction. When the radio signal power is reduced, the influences of interference and noise power are greatly received, which leads to a higher packet loss rate, and to longer delay time and greater variation in the delay time. Thus, when the distance between the control apparatus and the transport apparatus is large, there is great delay time variation from a time point at which the control command from the control apparatus is acquired to a time point at which the control command arrives at each of the transport apparatuses. When there is a great delay time variation in each of the transport apparatuses, the method in which the transport apparatuses are caused to synchronize with the operation start time of one of the transport apparatuses having the longest delay time has a problem in that delay time until a group of transport apparatuses start their operations is increased. When there is a long delay from a time point at which the control command from the control apparatus is acquired according to user operation to a time point at which a group of drones start their operations, operability of the transport apparatuses is deteriorated, which thus inhibits intuitive operation and then causes a problem of increase of fatigue of a user, for example.

In view of this, the present example embodiments are directed to perform appropriately cooperated operation between a plurality of transport apparatuses when transporting an object using the plurality of transport apparatuses. More specifically, the present example embodiments have an example object to enhance response performance and stability when a plurality of transport apparatuses (for example, drones) cooperate to transport an object (articles, goods, or the like) in an environment in which there is a variation in delay time related to communication.

### (2) Operation Examples

In the example embodiments of the present invention, for example, first control information for transporting an object is transmitted from a control apparatus to a first transport apparatus, and second control information for the first transport apparatus and a second transport apparatus to cooperate to transport the object is transmitted from the first transport apparatus to the second transport apparatus according to the first control information.

With this configuration, for example, appropriately cooperated operation between a plurality of transport apparatuses can be enabled when transporting an object using the plurality of transport apparatuses. Note that the above-described operation examples are specific examples of the example embodiments of the present invention, and as a matter of course, the example embodiments of the present invention are not limited to the above-described operation examples.

### 2. FIRST EXAMPLE EMBODIMENT

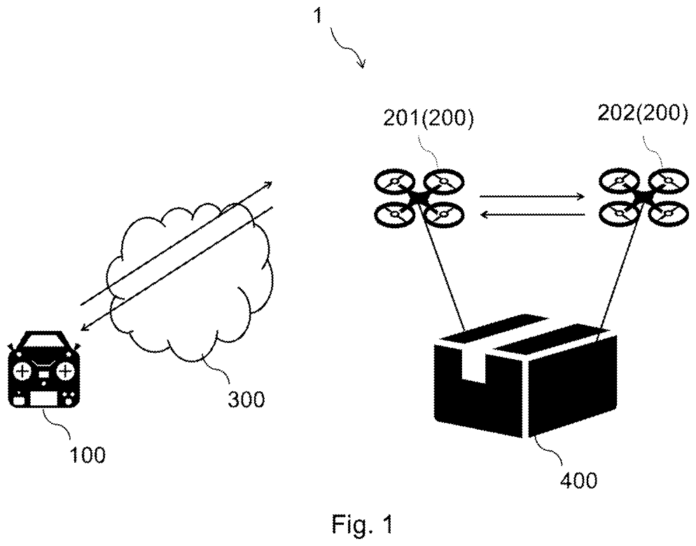

With reference to FIG. 1 to FIG. 6, a first example embodiment will be described.

### 2.1. Configuration of Transport Control System 1

First, with reference to FIG. 1, an example of a configuration of a transport control system 1 according to the first example embodiment will be described. FIG. 1 is an explanatory diagram illustrating an example of a schematic configuration of the transport control system 1 according to the first example embodiment.

With reference to FIG. 1, the transport control system 1 includes a control apparatus 100, two transport apparatuses 201 and 202 (simply referred to as “transport apparatus 200” when the two transport apparatuses 201 and 202 need not be distinguished), a communication network 300, and a transported object 400.

In the transport control system 1 having such a configuration, the control apparatus 100 controls the transport apparatuses 201 and 202 by performing radio communication via the communication network 300. The transport apparatuses 201 and 202 perform radio communication with each other. Each of the transport apparatuses 201 and 202 is physically connected to the transported object 400 via a wire or the like, for example, and performs transport of the transported object 400 by moving in the same direction. Each of the transport apparatuses 201 and 202 is, for example, an unmanned aircraft such as a drone. Note that each of the transport apparatuses 201 and 202 is not limited to an unmanned aircraft, and may be, for example, an unmanned transport vehicle or the like.

### 2.2. Configuration of Control Apparatus 100

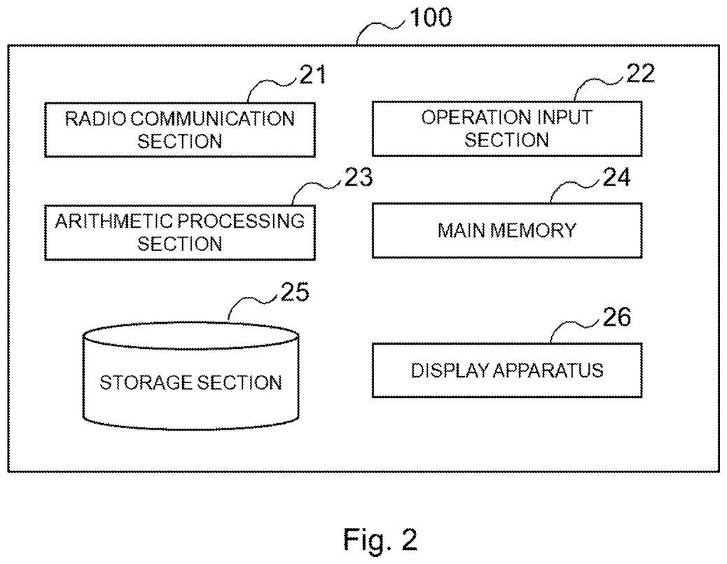

FIG. 2 is a block diagram illustrating an example of a hardware configuration of the control apparatus 100 according to the first example embodiment. With reference to FIG. 2, the control apparatus 100 includes a radio communication section 21, an operation input section 22, an arithmetic processing section 23, a main memory 24, a storage section 25, and a display apparatus 26.

The radio communication section 21 wirelessly transmits and receives a signal. For example, the radio communication section 21 receives a signal from the transport apparatus 200 via the communication network 300, and transmits a signal to the transport apparatus 200 via the communication network 300.

The operation input section 22 is an input interface that performs input processing of an operation request from a user who performs operation of the control apparatus 100.

The arithmetic processing section 23 is, for example, a central processing unit (CPU), a graphics processing unit (GPU), or the like. The main memory 24 is, for example, a random access memory (RAM), a read only memory (ROM), or the like.

The storage section 25 is, for example, a hard disk drive (HDD), a solid state drive (SSD), a memory card, or the like. The storage section 25 may be a memory such as a RAM and a ROM. Specifically, the storage section 25 temporarily or permanently stores programs (instructions) and parameters for operations of the control apparatus 100 as well as various data. The programs include one or more instructions for the operations of the control apparatus 100.

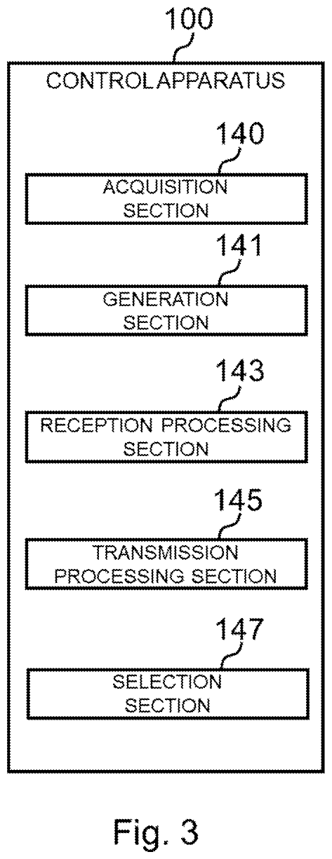

In the control apparatus 100, for example, programs for control stored in the storage section 25 are read in the main memory 24 and are executed by the arithmetic processing section 23, and the functional sections as illustrated in FIG. 3 are thereby implemented. These programs may be first read in the main memory 24 and then be executed, or may be executed without being read in the main memory 24. The main memory 24 and the storage section 25 also fulfill a role of storing information and data stored in constituent elements included in the control apparatus 100.

The above-described programs can be stored using various types of non-transitory computer readable media and supplied to a computer. The non-transitory computer readable medium includes various types of tangible storage media. Examples of the non-transitory computer readable medium include a magnetic storage medium (for example, a flexible disk, a magnetic tape, or a hard disk drive), a magneto-optical storage medium (for example, a magneto-optical disk), a compact disc-ROM (CD-ROM), a CD-recordable (CD-R), a CD-rewritable (CD-R/W), and a semiconductor memory (for example, a mask ROM, a programmable ROM (PROM), an erasable PROM (EPROM), a flash ROM, or a RAM. The programs may be supplied to a computer by various types of transitory computer readable media. Examples of the transitory computer readable medium include an electric signal, an optical signal, and an electromagnetic wave. The transitory computer readable medium can supply the programs to a computer via a wired communication path such as an electric cable and an optical fiber or a wireless communication path.

The display apparatus 26 is an apparatus that displays a screen corresponding to drawing data processed by the arithmetic processing section 23, such as a liquid crystal display (LCD), a cathode ray tube (CRT) display, and a monitor.

FIG. 3 is a block diagram illustrating an example of a functional configuration of the control apparatus 100 according to the first example embodiment. With reference to FIG. 3, the control apparatus 100 includes an acquisition section 140, a generation section 141, a reception processing section 143, a transmission processing section 145, and a selection section 147. Note that the control apparatus 100 may further include constituent elements other than these constituent elements.

### 2.3. Configuration of Transport Apparatus 200

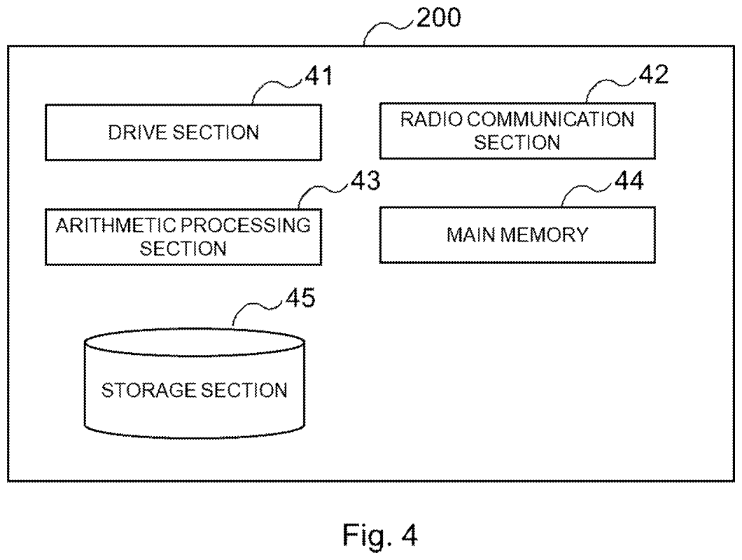

FIG. 4 is a block diagram illustrating an example of a hardware configuration of the transport apparatus 200 according to the first example embodiment. With reference to FIG. 4, the transport apparatus 200 includes a drive section 41, a radio communication section 42, an arithmetic processing section 43, a main memory 44, and a storage section 45.

The drive section 41 includes, for example, means for generating a driving force for moving the transport apparatus 200 such as a motor. For example, when the transport apparatus 200 is an unmanned aircraft such as a drone, a flight of the transport apparatus 200 is performed, with a rotor being rotated by the driving force generated by the drive section 41.

The radio communication section 42 wirelessly transmits and receives a signal. For example, the radio communication section 42 receives a signal from the control apparatus 100 via the communication network 300, and transmits a signal to the control apparatus 100 via the communication network 300. The radio communication section 42 performs transmission and reception of a signal to and from another transport apparatus 200.

The arithmetic processing section 43 is, for example, a central processing unit (CPU), a graphics processing unit (GPU), or the like. The main memory 44 is, for example, a random access memory (RAM), a read only memory (ROM), or the like.

The storage section 45 is, for example, a hard disk drive (HDD), a solid state drive (SSD), a memory card, or the like. The storage section 45 may be a memory such as a RAM and a ROM. Specifically, the storage section 45 temporarily or permanently stores programs (instructions) and parameters for operations of the transport apparatus 200 as well as various data. The program includes one or more instructions for the operations of the transport apparatus 200.

In the transport apparatus 200, for example, programs for control stored in the storage section 45 are read in the main memory 44 and are executed by the arithmetic processing section 43, and the functional sections as illustrated in FIG. 4 are thereby implemented. These programs may be first read in the main memory 44 and then be executed, or may be executed without being read in the main memory 44. The main memory 44 and the storage section 45 also fulfill a role of storing information and data stored in constituent elements included in the transport apparatus 200.

The above-described programs can be stored using various types of non-transitory computer readable media and supplied to a computer. The non-transitory computer readable medium includes various types of tangible storage media. Examples of the non-transitory computer readable medium include a magnetic storage medium (for example, a flexible disk, a magnetic tape, or a hard disk drive), a magneto-optical storage medium (for example, a magneto-optical disk), a compact disc-ROM (CD-ROM), a CD-recordable (CD-R), a CD-rewritable (CD-R/W), and a semiconductor memory (for example, a mask ROM, a programmable ROM (PROM), an erasable PROM (EPROM), a flash ROM, or a RAM. The programs may be supplied to a computer by various types of transitory computer readable media. Examples of the transitory computer readable medium include an electric signal, an optical signal, and an electromagnetic wave. The transitory computer readable medium can supply the programs to a computer via a wired communication path such as an electric cable and an optical fiber or a wireless communication path.

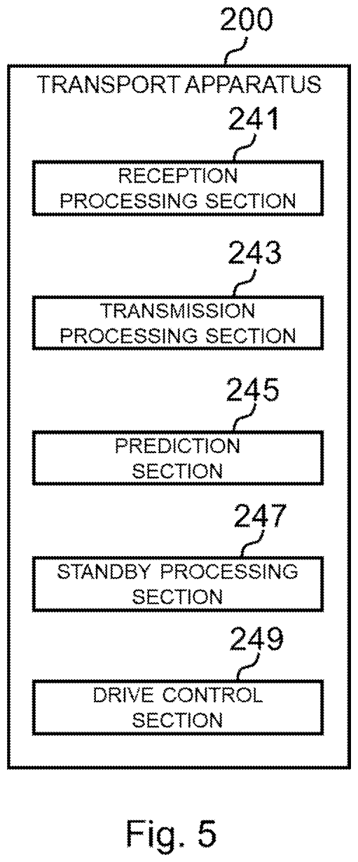

FIG. 5 is a block diagram illustrating an example of a functional configuration of the transport apparatus 200 according to the first example embodiment. With reference to FIG. 5, the transport apparatus 200 includes a reception processing section 241, a transmission processing section 243, a prediction section 245, a standby processing section 247, and a drive control section 249. Note that the transport apparatus 200 may further include constituent elements other than these constituent elements.

### 2.4. Operation Examples

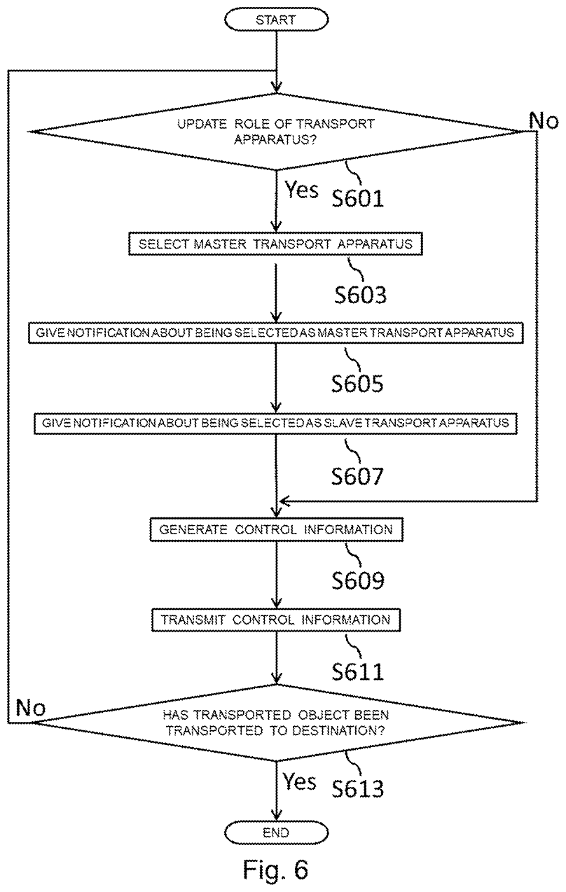

Next, with reference to FIG. 6 to FIG. 8, operation examples of the first example embodiment will be described.

### (1) Roles (Master, Slave) of Transport Apparatus

First, according to the first example embodiment, a role of a master transport apparatus or a slave transport apparatus is configured for the transport apparatus 200. The master transport apparatus is a transport apparatus that receives first control information for transporting the transported object 400 from the control apparatus 100. The slave transport apparatus is a transport apparatus that receives, from the master transport apparatus, second control information for the master transport apparatus and the slave transport apparatus to cooperate to transport the transported object 400. Among the transport apparatuses 201 and 202, for example, a transport apparatus that is predicted to have a stably small communication delay with the control apparatus 100 is configured as the master transport apparatus, and a transport apparatus that is not the master transport apparatus is configured as the slave transport apparatus.

As an example, when the communication delay between the transport apparatus 201 and the control apparatus 100 is predicted to be stably small in comparison to the communication delay between the transport apparatus 202 and the control apparatus 100, the transport apparatus 201 serves as the master transport apparatus, and the transport apparatus 202 serves as the slave transport apparatus.

In this case, the control apparatus 100 (transmission processing section 145) transmits the first control information for transporting the transported object 400 to the master transport apparatus (transport apparatus 201). Then, the transport apparatus 201 (transmission processing section 243) being the master transport apparatus transmits, from the master transport apparatus (transport apparatus 201) to the slave transport apparatus (transport apparatus 202), the second control information for the master transport apparatus (transport apparatus 201) and the slave transport apparatus (transport apparatus 202) to cooperate to transport the transported object 400.

Note that, in a case of a relationship opposite to the example described above, in other words, in a case in which the transport apparatus 202 is the master transport apparatus and the transport apparatus 201 is the slave transport apparatus, the first control information is transmitted from the control apparatus 100 to the transport apparatus 202, and the second control information is transmitted from the transport apparatus 202 to the transport apparatus 201.

In the following description of the first example embodiment, unless there is a reference made to a special exception, the transport apparatus 201 is the master transport apparatus, and the transport apparatus 202 is the slave transport apparatus.

According to the first example embodiment, for example, as will be described in the following, as compared to a case in which the control apparatus 100 individually transmits control information to each of the transport apparatuses 201 and 202, the transport apparatuses can appropriately cooperate to perform transport of the transported object 400 by taking the communication delay into consideration.

First, the distance between the control apparatus 100 and the transport apparatuses 201 and 202 varies depending on a transport state. Thus, it is possible that signal power of a radio signal from the control apparatus 100 is reduced due to an increase of the distance between the control apparatus 100 and the transport apparatuses 201 and 202, intervention of an obstruction between the control apparatus 100 and the transport apparatuses 201 and 202, or the like, for example.

In such a case, communication quality between the control apparatus 100 and each of the transport apparatuses 201 and 202 may become unstable, the delay time may be increased, and further, the delay variation may be increased. Thus, when the operation start time of the transport apparatus (for example, the transport apparatus 201) is synchronized with the operation start time of the transport apparatus (for example, the transport apparatus 202) having the longest delay time, the delay time until a group of transport apparatuses 201 and 202 start their operations may be increased.

In contrast, the distance between the transport apparatus 201 and the transport apparatus 202 does not significantly vary even if the transport state changes, because the transport apparatus 201 and the transport apparatus 202 are connected to the transported object 400 with a wire or the like. Thus, it can be considered that the communication quality between the transport apparatus 201 and the transport apparatus 202 is generally stable, and the delay time is stably short as well.

Therefore, according to the first example embodiment, a role that the master transport apparatus relays input of the control command to the slave transport apparatus is fulfilled, and thus, average delay time from when the control command is input into the control apparatus 100 to when a group of transport apparatuses 201 and 202 start moving can be reduced, for example.

### (2) Control Information

For example, the control apparatus 100 (acquisition section 140) receives user's operation input into the operation input section 22. In response to the user's operation, the control apparatus 100 (generation section 141) generates, as the first control information, control information including transport instruction information (hereinafter also referred to as master transport instruction information) for performing transport instruction to the master transport apparatus and transport instruction information (also referred to as slave transport instruction information) for performing transport instruction to the slave transport apparatus. Then, the control apparatus 100 (transmission processing section 145) transmits these pieces of transport instruction information to the master transport apparatus (transport apparatus 201). In other words, the first control information includes the master transport instruction information and the slave transport instruction information, and is transmitted from the control apparatus 100 to the master transport apparatus (transport apparatus 201).

In this case, the master transport apparatus (the transmission processing section 243 of the transport apparatus 201) transmits (transfers) the slave transport instruction information received from the control apparatus 100 to the slave transport apparatus (for example, the transport apparatus 202) as the second control information.

### (3) Transport Operation in View of Delay Time

The master transport apparatus (the prediction section 245 of the transport apparatus 201) predicts a delay time from transmission of the slave transport instruction information by the master transport apparatus (transport apparatus 201) to start of execution of processing according to the slave transport instruction information by the slave transport apparatus (transport apparatus 202), based on a response (ACK message) from the slave transport apparatus (transport apparatus 202) in response to the transmission of the slave transport instruction information to the slave transport apparatus (transport apparatus 202).

The master transport apparatus (the standby processing section 247 of the transport apparatus 201) stands by to execute processing according to the master transport instruction information until the predicted delay time elapses. Subsequently, the master transport apparatus (the drive control section 249 of the transport apparatus 201) drives the drive section 41 (controls the drive section 41) in accordance with the timing at which the slave transport apparatus (transport apparatus 202) starts its operation.

On the other hand, when the slave transport apparatus (transport apparatus 202) receives the slave transport instruction information from the master transport apparatus (transport apparatus 201), the slave transport apparatus (transport apparatus 202) immediately starts driving the drive section 41 (a motor or the like) according to the slave transport instruction information. The slave transport apparatus returns a response message (ACK message) to the master transport apparatus (for example, the transport apparatus 201).

Owing to the transport operation in view of the delay time as described above, the master transport apparatus (for example, the transport apparatus 201) and the slave transport apparatus (for example, the transport apparatus 202) can simultaneously start their operations according to the instruction from the control apparatus 100, and can appropriately transport the transported object 400 to a destination.

### (4) Flow of Processing

(4-1) Flow of Processing Performed by Control Apparatus 100

FIG. 6 is a flowchart illustrating a flow of processing performed by the control apparatus 100. With reference to FIG. 6, the flow of processing performed by the control apparatus 100 will be described.

First of all, the control apparatus 100 (selection section 147) determines whether it is timing to update the roles of the master transport apparatus and the slave transport apparatus out of the transport apparatuses 201 and 202 (Step S601). When it is the timing to perform update (S601: Yes), the processing of Step S603 is performed. Otherwise (S601: No), the processing of Step S609 is performed.

Here, the timing to update the role of the transport apparatus may be once every predetermined seconds, or may be timing at which the control information is transmitted a predetermined number of times. Note that the timing to update the role of the transport apparatus may only be at the time of initial configuration, or may be any timing.

In Step S603, the control apparatus 100 (selection section 147) selects the master transport apparatus out of the transport apparatuses 201 and 202. Here, for the criterion for selecting the master transport apparatus, for example, received signal strength (received signal strength indicator (RSSI)) is used. Each of the transport apparatuses 201 and 202 (transmission processing section 243) transmits its RSSI to the control apparatus 100. When the RSSI is high, it is considered that the probability of transmission with no errors of signals is high and the communication delay is stably small, and thus the control apparatus 100 selects the transport apparatus having the highest RSSI as the master transport apparatus.

Note that the selection criterion for the master transport apparatus need not necessarily be the RSSI described above, and may be other radio signal received power information, for example, a signal-to-noise ratio (signal-to-interference plus noise power ratio (SINR)).

The selection criterion for the master transport apparatus may be, for example, a delay of communication performed between the transport apparatuses 201 and 202 and the control apparatus 100. Specifically, the control apparatus 100 may measure time variation in the delay time, and may select the transport apparatus having the smallest variation in the delay time or the transport apparatus having the smallest average delay time as the master transport apparatus.

Next, the control apparatus 100 (transmission processing section 145) transmits, to the transport apparatus (transport apparatus 201) selected as the master transport apparatus, notification information that gives notification about being selected as the master transport apparatus (Step S605).

Next, the control apparatus 100 (transmission processing section 145) transmits, to the transport apparatus (transport apparatus 202) not selected as the master transport apparatus, information that gives notification about being selected as the slave transport apparatus (Step S607).

Next, the control apparatus 100 (generation section 141) generates the control information including the master transport instruction information and the slave transport instruction information in response to an operation input from a user of the control apparatus 100 (Step S609).

Next, the control apparatus 100 (transmission processing section 145) receives the control information from the generation section 141, and transmits the control information to the master transport apparatus (transport apparatus 201) (Step S611).

Next, the control apparatus 100 determines whether the transported object 400 is transported to a destination (Step S613). For example, the control apparatus 100 may determine that the transported object 400 has been transported by receiving an input indicating completion of the transport from the user who had stood by at the destination of the transported object 400. The determination may be performed based on a signal from light detection and ranging, or laser imaging detection and ranging, (LIDAR) connected so as to be able to communicate with the control apparatus 100, or based on position information recognized by a GPS receiver equipped with each of the transport apparatuses 200.

In Step S613, when it is determined that the transported object 400 has been transported to the destination (S613: Yes), the processing illustrated in FIG. 6 is terminated; or otherwise (S613: No), the processing returns to the processing of Step S601.

(4-2) Flow of Processing Performed by Master Transport Apparatus

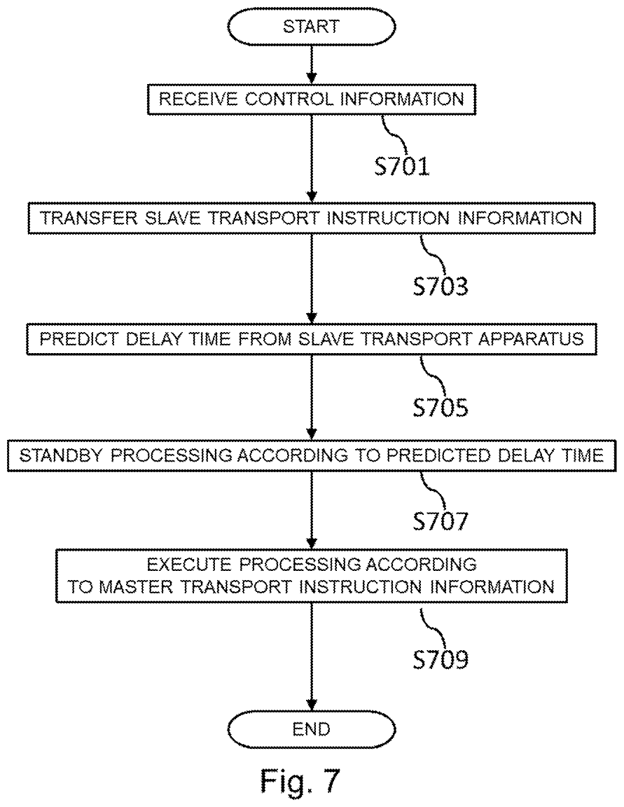

FIG. 7 is a flowchart illustrating a flow of processing performed by the master transport apparatus. With reference to FIG. 7, the flow of processing performed by the master transport apparatus will be described.

First of all, the transport apparatus 201 (reception processing section 241) receives the control information including the master transport instruction information and the slave transport instruction information from the control apparatus 100 (Step S701).

Next, the transport apparatus 201 (transmission processing section 243) transfers the slave transport instruction information included in the control information received in Step S701 to the transport apparatus 202 (Step S703). Here, the second control information transmitted from the master transport apparatus to the slave transport apparatus need not necessarily be the same information as the slave transport instruction information on the condition that information on the slave transport instruction information is included. In other words, the transport apparatus 201 (transmission processing section 243) does not necessarily transfer the slave transport instruction information received from the control apparatus 100 to the transport apparatus 202, but may also change (modify) the slave transport instruction information based on position information of the transport apparatus 202 estimated after a predetermined time, and transmit the slave transport instruction information thus changed (modified) to the transport apparatus 202. In this case, for example, the transport apparatus 201 predicts the positions of the transport apparatuses 201 and 202 and the transported object 400 after the predetermined time and the transport apparatus 202 moves to the spot to be present in the future (after the predetermined time), and thus the transport apparatus 201 may perform transmission after modifying the slave transport instruction information.

Next, the transport apparatus 201 (prediction section 245) predicts the delay time from a time point at which the slave transport instruction information is transmitted by the transport apparatus 201 to a time point at which the transport apparatus 202 starts its operation, based on time series data of an ACK message being a response message from the transport apparatus 202 in response to the transmission of the slave transport instruction information (Step S705).

Next, the transport apparatus 201 (standby processing section 247) stands by to execute processing according to the master transport instruction information for the delay time predicted in Step S705 (Step S707).

Next, when the standby processing by the standby processing section 247 completes, the transport apparatus 201 (drive control section 249) immediately transmits a drive control signal to the drive section 41 according to the master transport instruction information to cause the drive section 41 to start its operation, and then terminates the processing illustrated in FIG. 5.

(4-3) Flow of Processing Performed by Slave Transport Apparatus

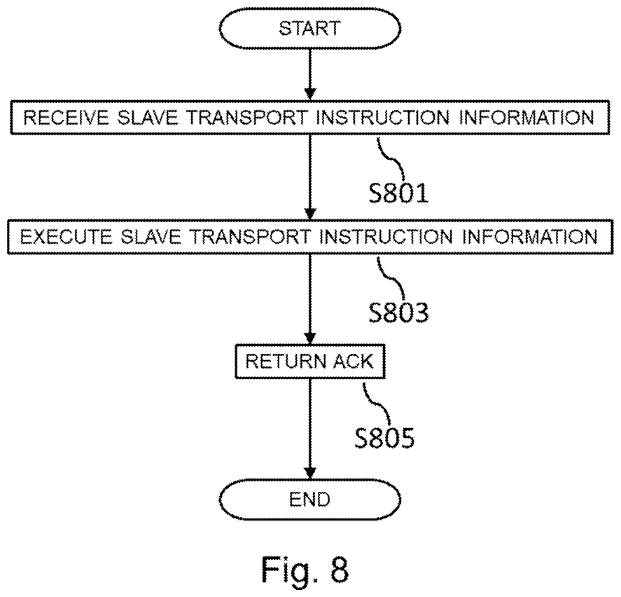

FIG. 8 is a flowchart illustrating a flow of processing performed by the slave transport apparatus. With reference to FIG. 8, the flow of processing performed by the slave transport apparatus will be described.

First of all, the transport apparatus 202 (reception processing section 241) receives the slave transport instruction information from the transport apparatus 201 (Step S801). Next, the transport apparatus 202 (drive control section 249) starts operation (control) of the drive section 41 according to the slave transport instruction information received in Step S801 (Step S803). Next, when the transport apparatus 202 (transmission processing section 243) starts the operation according to the slave transport instruction information, the transport apparatus 202 (transmission processing section 243) transmits an ACK message to the transport apparatus 201, and then terminates the processing illustrated in FIG. 8 (Step S805).

(4-4) Summary

As described above, according to the first example embodiment, when a group of transport apparatuses 201, 202, and 203 are caused to operate simultaneously with each other, a delay time from when a user inputs operation into the control apparatus 100 to when the group of transport apparatuses 201, 202, and 203 start moving can be reduced, with the operation start timing of each of the transport apparatuses 201, 202, and 203 being synchronized with each other.

### (5) Example Alterations

Various changes can be made to the first example embodiment in addition to the above-described operation examples.

(Example Using Capability Information)

For example, the control apparatus 100 (selection section 147) may select the master transport apparatus and the slave transport apparatus out of the transport apparatuses 201 and 202, based on capability information of the transport apparatus 200, such as operating time and a remaining battery, for example.

(Example Using Weight Information of Transported Object)

The control apparatus 100 may change various operations according to weight information of the transported object 400.

For example, the control apparatus 100 (selection section 147) may select the master transport apparatus and the slave transport apparatus out of the transport apparatuses 201 and 202, based on the weight information of the transported object 400. Specifically, when the weight of the transported object 400 is large and one transport apparatus serves as the master transport apparatus for a long time, there is a great load. Thus, the control apparatus 100 (selection section 147) may perform selection of the master transport apparatus and the slave transport apparatus such that the role of the transport apparatus is more frequently updated as the weight of the transported object 400 is larger.

The control apparatus 100 (generation section 141) may generate the transport instruction information (the master transport instruction information and the slave transport instruction information) for reducing the distance between the transport apparatuses 201 and 202 as the weight of the transported object 400 is larger according to the weight information of the transported object 400.

(Example Using Environment Information)

The control apparatus 100 (generation section 141) may generate the master transport instruction information and the slave transport instruction information for performing control related to a flight route (for example, a route, a height, or the like), based on environment information of the transport apparatuses 201 and 202, such as wind speed information and moving route information of neighboring transport apparatuses.

(Example Alteration Related to Operation of Master Transport Apparatus)

The master transport apparatus (for example, the prediction section 245 of the transport apparatus 201) may predict the delay time, based on communication performed with the slave transport apparatus at the time of test transport or at the time of moving to the original place from which the goods are transported.

(Example Alteration Related to Configuration of Slave Transport Apparatus)

The slave transport apparatus need not necessarily have the same functional configuration as the master transport apparatus, and may have, for example, a slave-dedicated configuration. In other words, the slave transport apparatus may include only the reception processing section 241, the transmission processing section 243, and the drive control section 249 out of the functional configuration illustrated in FIG. 4, and can implement the function as the slave transport apparatus with these functional sections.

(Additional Notes)

The functional constituent elements included in the control apparatus 100 may be executed in separate apparatuses. For example, the acquisition section 140 may be implemented in an apparatus different from the control apparatus 100. In this case, for example, the acquisition section 140 may be an input-dedicated device such as a tablet terminal, and may transmit input information to the control apparatus 100.

### 3. SECOND EXAMPLE EMBODIMENT

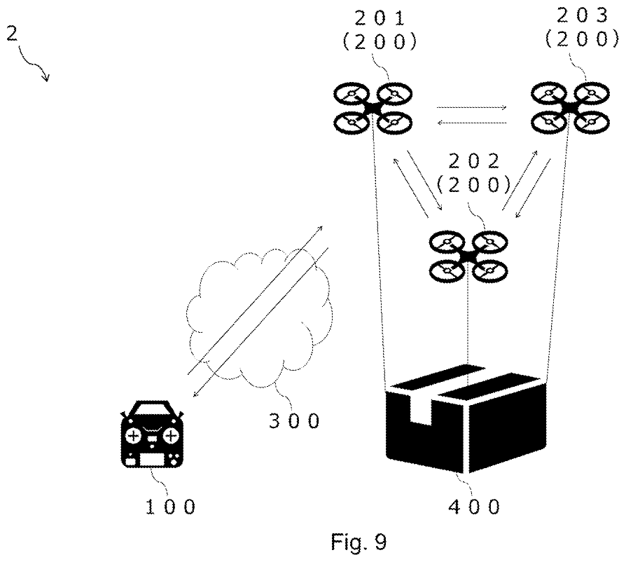

Next, with reference to FIG. 9 to FIG. 11, a second example embodiment will be described.

### 3.1. Configuration of Transport Control System 2

First, with reference to FIG. 9, an example of a configuration of a transport control system 2 according to the second example embodiment will be described. FIG. 9 is an explanatory diagram illustrating an example of a schematic configuration of the transport control system 2 according to the second example embodiment.

With reference to FIG. 9, the transport control system 2 includes a control apparatus 100, three transport apparatuses 201, 202, and 203 (simply referred to as “transport apparatus 200” when the three transport apparatuses 201, 202, and 203 need not be distinguished), a communication network 300, and a transported object 400.

In the transport control system 2 having such a configuration, the communication network 300 corresponds to the communication network 300 according to the first example embodiment. The transported object 400 corresponds to the transported object 400 according to the first example embodiment. The control apparatus 100 performs radio communication with the transport apparatuses 201, 202, and 203 via the communication network 300. The hardware configuration and the functional configuration of the control apparatus 100 are similar to the configurations illustrated in FIG. 2 and FIG. 3 referred to in the first example embodiment, respectively, and thus description thereof will be omitted. The transport apparatuses 201, 202, and 203 perform radio communication with each other. Each of the transport apparatuses 201, 202, and 203 is physically connected to the transported object 400 via a wire or the like, for example, and performs transport of the transported object 400 by moving in the same direction. Each of the transport apparatuses 201, 202, and 203 is, for example, an unmanned aircraft such as a drone. Note that each of the transport apparatuses 201, 202, and 203 is not limited to an unmanned aircraft, and may be, for example, an unmanned transport vehicle or the like. The hardware configuration and the functional configuration of the transport apparatus 200 are similar to the configurations illustrated in FIG. 4 and FIG. 5 referred to in the first example embodiment, respectively, and thus description thereof will be omitted.

### 3.2. Operation Examples

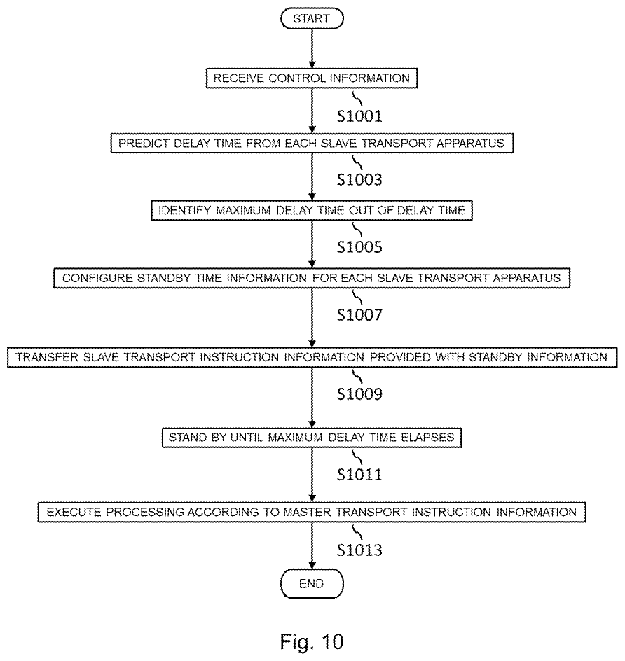

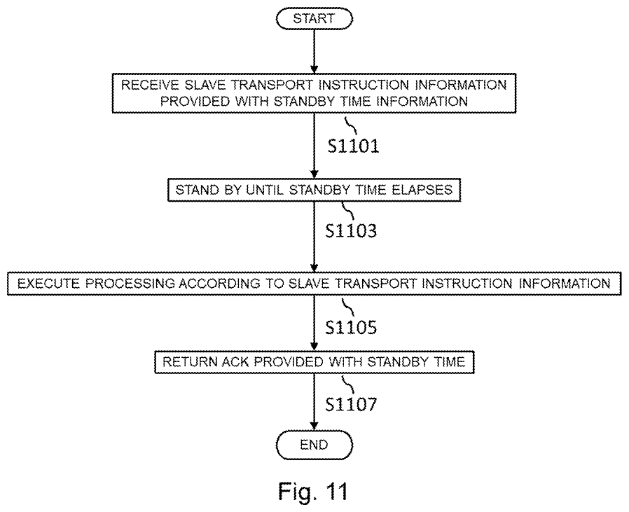

Next, with reference to FIG. 10 and FIG. 11, operation examples of the second example embodiment will be described.

According to the second example embodiment, among the transport apparatuses 201, 202, and 203, a transport apparatus that is predicted to have a stably small communication delay with the control apparatus 100 is configured as the master transport apparatus, and transport apparatuses that are not the master transport apparatus are configured as the slave transport apparatuses.

For example, when the communication delay between the transport apparatus 201 and the control apparatus 100 is predicted to be stably small in comparison to the communication delay between each of the transport apparatuses 202 and 203 and the control apparatus 100, the transport apparatus 201 serves as the master transport apparatus, and the transport apparatuses 202 and 203 each serve as the slave transport apparatus.

In this case, the control apparatus 100 (transmission processing section 145) transmits the first control information for transporting the transported object 400 to the master transport apparatus (transport apparatus 201).

The master transport apparatus (the standby processing section 247 of the transport apparatus 201) configures a standby time for which the slave transport apparatuses (transport apparatuses 202 and 203) stand by to perform processing according to the first control information, based on communication with each of the two slave transport apparatuses (transport apparatuses 202 and 203). Then, the master transport apparatus (the transmission processing section 243 of the transport apparatus 201) adds information (hereinafter also referred to as standby time information) related to the standby time to the second control information for the master transport apparatus (transport apparatus 201) and the two slave transport apparatuses (transport apparatuses 202 and 203) to cooperate to transport the transported object 400. The master transport apparatus (the transmission processing section 243 of the transport apparatus 201) transmits the second control information from the master transport apparatus (transport apparatus 201) to each of the two slave transport apparatuses (transport apparatuses 202 and 203). Note that the information on the standby time need not necessarily be transmitted at the same timing as the second control information; however, for the sake of convenience, the following description is based on the assumption that the information on the standby time is transmitted at the same timing as the second control information.

The slave transport apparatuses (the reception processing section 241 of each of the transport apparatuses 202 and 203) receive the second control information including the standby time information. Then, the slave transport apparatuses (for example, the standby processing section 247 of each of the transport apparatuses 202 and 203) perform standby processing according to the standby time information. Subsequently, the slave transport apparatuses (transport apparatuses 202 and 203) drive (start controlling) the drive section 41 according to the second control information.

According to the configuration in which the slave transport apparatuses (transport apparatuses 202 and 203) stand by to start the operation (control) of the drive section 41 based on the standby time information as described above, the master transport apparatus (transport apparatus 201) and the slave transport apparatuses (transport apparatuses 202 and 203) can simultaneously start their operations in accordance with the instruction from the control apparatus 100, and can appropriately transport the transported object 400 to the destination.

Note that, in the second example embodiment, the transport apparatus 201 need not necessarily be selected as the master transport apparatus, and for example, the transport apparatus 202 or the transport apparatus 203 may be selected as the master transport apparatus. In the following description of the first example embodiment, unless there is a reference made to a special exception, the transport apparatus 201 is the master transport apparatus, and the transport apparatus 202 is the master transport apparatus.

### (1) Control Information

According to the second example embodiment, similarly to the first example embodiment, the control apparatus 100 (acquisition section 140) receives user's operation input into the operation input section 22. In response to the user's operation, the control apparatus 100 (generation section 141) generates the control information including the master transport instruction information and the slave transport instruction information as the first control information. Then, the control apparatus 100 (transmission processing section 145) transmits these pieces of transport instruction information to the master transport apparatus (transport apparatus 201). Then, the master transport apparatus (the transmission processing section 243 of the transport apparatus 201) transmits (transfers) the slave transport instruction information received from the control apparatus 100 to the two slave transport apparatuses (transport apparatuses 202 and 203) as the second control information.

### (2) Configuration of Standby Time

The master transport apparatus (transport apparatus 201) performs configuration of the standby time as follows.

First, the master transport apparatus (the prediction section 245 of the transport apparatus 201) predicts a delay time required for processing according to the slave transport instruction information for each of the slave transport apparatuses (transport apparatuses 202 and 203) based on communication with the slave transport apparatuses (transport apparatuses 202 and 203), and identifies the maximum delay time from such predicted pieces of delay information.

Then, based on the maximum delay time, for example, the master transport apparatus (the standby processing section 247 of the transport apparatus 201) configures the standby time for causing other slave transport apparatuses (for example, the transport apparatus 202) to start their operations in accordance with the timing at which the slave transport apparatus (for example, the transport apparatus 203) whose delay time is the maximum delay time starts its operation.

### (3) Flow of Processing

(3-1) Flow of Processing Performed by Control Apparatus 100

First, processing performed by the control apparatus 100 is similar to the processing described with reference to FIG. 6 in the first example embodiment, and thus description thereof will be omitted.

(3-2) Flow of Processing Performed by Master Transport Apparatus

FIG. 10 is a flowchart illustrating a flow of processing performed by the master transport apparatus. With reference to FIG. 10, the flow of processing performed by the master transport apparatus will be described.

First of all, the transport apparatus 201 (reception processing section 241) receives the control information including the master transport instruction information and the slave transport instruction information from the control apparatus 100 (Step S1001).

Next, the transport apparatus 201 (prediction section 245) predicts a delay time ti for each of the transport apparatuses 202 and 203, based on time series data of an ACK message received from the transport apparatuses 202 and 203, the delay time ti being a delay time from the time at which the slave transport instruction information is transmitted by the transport apparatus 201 to the time when operation according to the slave transport instruction information is started by the transport apparatuses 202 and 203 (Step S1003). Here, i included in the delay time ti is a value for identifying the transport apparatuses 202 and 203. For example, the delay time regarding the transport apparatus 202 is represented by delay time t1, and the delay time regarding the transport apparatus 203 is represented by delay time t2.

Next, the transport apparatus 201 (prediction section 245) compares the delay times regarding each of the slave transport apparatuses (transport apparatuses 202 and 203) predicted in Step S1003, and identifies maximum delay time max(ti) (Step S1005).

Next, the transport apparatus 201 (standby processing section 247) identifies the standby time information regarding each of the slave transport apparatuses (S1007).

Here, suppose the standby time is set to 0. In this case, the time point at which the slave transport apparatus i starts the operation according to the slave transport instruction information is after ti has elapsed since the master transport apparatus transmits the slave transport instruction information to the slave transport apparatus. In contrast, the time point at which the slave transport apparatus having the maximum delay time starts the operation according to the slave transport instruction information is after the maximum delay time max(ti) has elapsed since the master transport apparatus transmits the slave transport instruction information to the slave transport apparatus. Thus, with the slave transport apparatus i delaying the timing to start the operation according to the slave transport instruction information by the standby time given by −ti+max(ti), all of the transport apparatuses 201, 202, and 203 can simultaneously start their operations. For the above reason, the standby processing section 247 determines the standby time information (−ti+max(ti)) corresponding to each of the slave transport apparatuses i.

Next, the transport apparatus 201 (transmission processing section 243) transmits the slave transport instruction information provided with the standby time information (−ti+max(ti)) to each of the slave transport apparatuses (Step S1009). Note that, in this step, the transport apparatus 201 (transmission processing section 243) does not necessarily transfer the slave transport instruction information received from the control apparatus 100 to the transport apparatus 202, but may also transmit the slave transport instruction information subjected to various modifications as described in the first example embodiment to the transport apparatuses 202 and 203.

Next, the transport apparatus 201 (standby processing section 247) stands by to execute processing according to the master transport instruction information until the maximum delay time max(ti) elapses (Step S1011).

Next, when the standby processing by the standby processing section 247 completes, the transport apparatus 201 (drive control section 249) immediately transmits a drive control signal to the drive section 41 according to the master transport instruction information to cause the drive section 41 to start its operation (Step S1013), and then terminates the processing illustrated in FIG. 10.

(3-3) Flow of Processing Performed by Slave Transport Apparatus

FIG. 11 is a flowchart illustrating a flow of processing performed by the slave transport apparatus. With reference to FIG. 11, the flow of processing performed by the slave transport apparatus will be described.

First of all, each of the transport apparatuses 202 and 203 (reception processing section 241) receives the slave transport instruction information including the standby time information (Step S1101).

Next, each of the transport apparatuses 202 and 203 (standby processing section 247) stands by to execute processing according to the slave transport instruction information until the time (−ti+max(ti)) indicated by the standby time information elapses (Step S1103).

Next, each of the transport apparatuses 202 and 203 (drive control section 249) executes the processing according to the slave transport instruction information received in Step S1101, and starts operation (control) of the drive section 41 (Step S1104).

Next, each of the transport apparatuses 202 and 203 (transmission processing section 243) transmits an ACK message provided with information indicating the standby time of the execution of the processing in Step S1103 to the transport apparatus 201, and terminates the processing illustrated in FIG. 11 (Step S1107).

(3-4) Summary

As described above, according to the second example embodiment, when a group of transport apparatuses 201, 202, and 203 are caused to operate simultaneously with each other, a delay time from when a user inputs operation into the control apparatus 100 to when the group of transport apparatuses 201, 202, and 203 start moving can be reduced, with the operation start timing of each of the transport apparatuses 201, 202, and 203 being synchronized with each other.

### (4) Example Alterations

Various changes can be made to the second example embodiment in addition to the above-described operation examples.

(Example Using Capability Information)

For example, the control apparatus 100 (selection section 147) may select the master transport apparatus and the slave transport apparatus out of the transport apparatuses 201, 202, and 203, based on capability information of the transport apparatus 200, such as operating time and a remaining battery, for example.

(Example Using Weight Information of Transported Object)

The control apparatus 100 may change various operations according to weight information of the transported object 400.

For example, the control apparatus 100 (selection section 147) may select the master transport apparatus and the slave transport apparatus out of the transport apparatuses 201, 202, and 203, based on the weight information of the transported object 400. Specifically, when the weight of the transported object 400 is large and one transport apparatus serves as the master transport apparatus for a long time, there is a great load. Thus, the control apparatus 100 (selection section 147) may perform selection of the master transport apparatus and the slave transport apparatus such that the role of the transport apparatus is more frequently updated as the weight of the transported object 400 is larger.

The control apparatus 100 (generation section 141) may generate the transport instruction information (the master transport instruction information and the slave transport instruction information) for reducing the distance between the transport apparatuses 201, 202, and 203 as the weight of the transported object 400 is larger according to the weight information of the transported object 400.

(Example Using Environment Information)

The control apparatus 100 (generation section 141) may generate the master transport instruction information and the slave transport instruction information for performing control related to a flight route (for example, a route, a height, or the like), based on environment information of the transport apparatuses 201, 202, and 203, such as wind speed information and moving route information of neighboring transport apparatuses.

(Example Alteration Related to Operation of Master Transport Apparatus)

The master transport apparatus (for example, the prediction section 245 of the transport apparatus 201) may predict the delay time, based on communication performed with the slave transport apparatus at the time of test transport or at the time of moving to the original place from which the goods are transported.

(Example Alteration Related to Configuration of Slave Transport Apparatus)

The slave transport apparatus need not necessarily have the same functional configuration as the master transport apparatus, and may have, for example, a slave-dedicated configuration. In other words, the slave transport apparatus may include only the reception processing section 241, the transmission processing section 243, and the drive control section 249 out of the functional configuration illustrated in FIG. 4, and can implement the function as the slave transport apparatus with these functional sections.

### 4. THIRD EXAMPLE EMBODIMENT

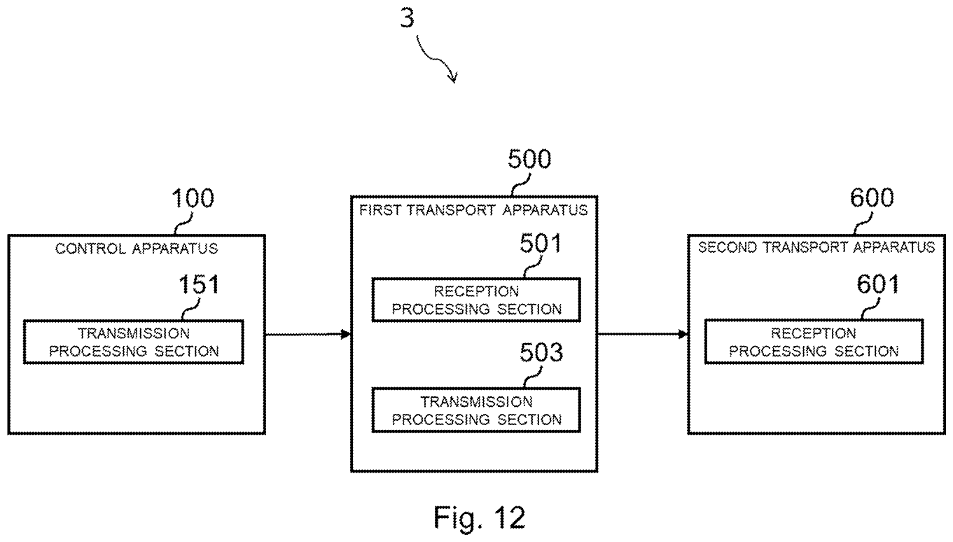

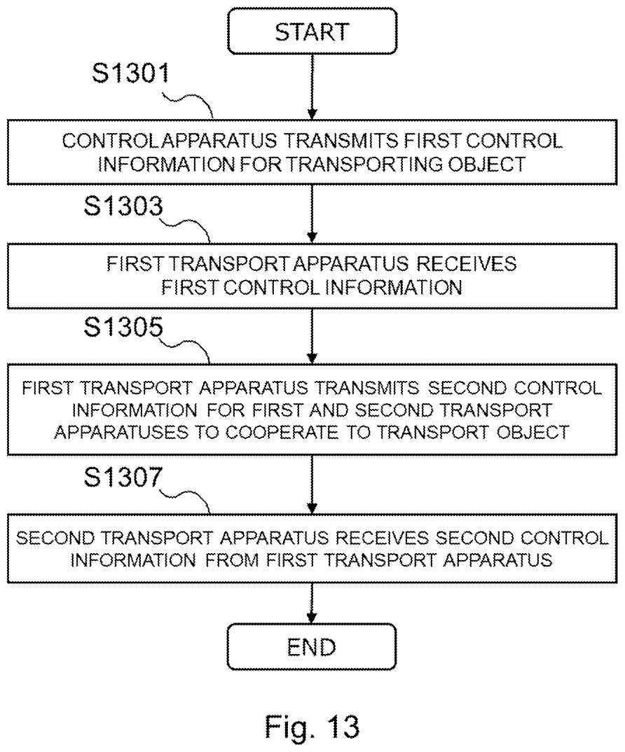

Next, with reference to FIG. 12 and FIG. 13, a third example embodiment of the present invention will be described. The first and second example embodiments described above are specific example embodiments, whereas the third example embodiment is a more generalized example embodiment.

### 4.1. Configuration of Transport Control System 3

First, with reference to FIG. 12, an example of a configuration of a transport control system 3 according to the third example embodiment will be described. FIG. 12 is an explanatory diagram illustrating an example of a schematic configuration of the transport control system 3 according to the third example embodiment.

With reference to FIG. 12, the transport control system 3 includes a control apparatus 100, a first transport apparatus 500, and a second transport apparatus 600.

The control apparatus 100 includes a transmission processing section 151. The transmission processing section 151 is implemented with, for example, a processor and a memory (e.g., a nonvolatile memory and/or a volatile memory) and/or a hard disk.

The first transport apparatus 500 includes a reception processing section 501 and a transmission processing section 503. The reception processing section 501 and the transmission processing section 503 may be implemented with one or more processors and a memory (e.g., a nonvolatile memory and/or a volatile memory) and/or a hard disk. The reception processing section 501 and the transmission processing section 503 may be implemented with the same processor, or may be implemented with separate processors. The memory may be included in the one or more processors or may be provided outside the one or more processors.

The second transport apparatus 600 includes a reception processing section 601. The reception processing section 601 is implemented with, for example, a processor and a memory (e.g., a nonvolatile memory and/or a volatile memory) and/or a hard disk.

### 4.2. Operation Examples

Operation examples according to the third example embodiment will be described. FIG. 13 is a diagram for describing a flow of processing performed by the transport control system 3 according to the third example embodiment.

According to the third example embodiment, the control apparatus 100 (transmission processing section 151) transmits the first control information for transporting an object to the first transport apparatus 500 (Step S1301). Next, the first transport apparatus 500 (reception processing section 501) receives the first control information from the control apparatus 100 (Step S1303). Next, the first transport apparatus 500 (transmission processing section 503) transmits the second control information for the first transport apparatus 500 and the second transport apparatus 600 to cooperate to transport the object to the second transport apparatus 600 according to the first control information (Step S1305). Next, the second transport apparatus 600 (reception processing section 601) receives the second control information from the first transport apparatus 500 (Step S1307).

Relationship with First and Second Example Embodiments

As an example, the transmission processing section 151 included in the control apparatus 100 may perform operation of the transmission processing section 145 included in the control apparatus 100 in the first or second example embodiment. The reception processing section 501 and the transmission processing section 503 included in the first transport apparatus 500 may perform operations of the reception processing section 143 and the transmission processing section 145 included in the transport apparatus 200 in the first or second example embodiment, respectively. In addition, the reception processing section 601 included in the second transport apparatus 600 may perform operation of the reception processing section 143 included in the transport apparatus 200 in the first or second example embodiment. In this case, description regarding the first or second example embodiment may also be applied to the third example embodiment.

Note that the third example embodiment is not limited to this example.

The third example embodiment has been described above. According to the third example embodiment, for example, appropriately cooperated operation between the transport apparatuses can be enabled when transporting the object using the plurality of transport apparatuses.

### 5. OTHER EXAMPLE EMBODIMENTS

Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

For example, the steps in the processing described in the Specification may not necessarily be executed in time series in the order described in the flowchart. For example, the steps in the processing may be executed in an order different from that described in the flowchart or may be executed in parallel. Some of the steps in the processing may be deleted, or more steps may be added to the processing.

An apparatus including constituent elements (e.g., the generation section, the reception processing section, the transmission processing section, the and/or the selection section) of the control apparatus described in the Specification (e.g., one or more apparatuses (or units) among a plurality of apparatuses (or units) constituting the control apparatus or a module for one of the plurality of apparatuses (or units)) may be provided. Moreover, methods including processing of the constituent elements may be provided, and programs for causing a processor to execute processing of the constituent elements may be provided. Moreover, non-transitory computer readable recording media (non-transitory computer readable media) having recorded thereon the programs may be provided. It is apparent that such apparatuses, modules, methods, programs, and non-transitory computer readable recording media are also included in the present invention.

An apparatus including constituent elements (e.g., the reception processing section, the transmission processing section, the prediction section, the standby processing section, and/or the drive control section) of the transport apparatus described in the Specification (e.g., one or more apparatuses (or units) among a plurality of apparatuses (or units) constituting the transport apparatus or a module for one of the plurality of apparatuses (or units)) may be provided. Moreover, methods including processing of the constituent elements may be provided, and programs for causing a processor to execute processing of the constituent elements may be provided. Moreover, non-transitory computer readable recording media (non-transitory computer readable media) having recorded thereon the programs may be provided. It is apparent that such apparatuses, modules, methods, programs, and non-transitory computer readable recording media are also included in the present invention.

The whole or part of the example embodiments disclosed above can be described as in the following supplementary notes, but are not limited to the following.

(Supplementary Note 1)

A transport control method including:

receiving, from a control apparatus, first control information for transporting an object; and

transmitting, from a first transport apparatus to a second transport apparatus, second control information for the first transport apparatus and the second transport apparatus to cooperate to transport the object according to the first control information.

(Supplementary Note 2)

The transport control method according to supplementary note 1, further including:

predicting a delay time from transmission of the second control information by the first transport apparatus to start of execution of processing according to the second control information by the second transport apparatus, based on a response from the second transport apparatus in response to the transmission of the second control information; and

standing by to execute processing according to the first control information until the delay time elapses.

(Supplementary Note 3)

The transport control method according to supplementary note 1, further including:

identifying a standby time for causing the second transport apparatus to stand by to execute the processing according to the second control information, based on communication between the first transport apparatus and the second transport apparatus; and

transmitting standby time information on the standby time from the first transport apparatus to the second transport apparatus.

(Supplementary Note 4)

The transport control method according to supplementary note 3, wherein

the second transport apparatus is one of a plurality of second transport apparatuses.

(Supplementary Note 5)

The transport control method according to supplementary note 4, further including:

predicting the delay time from the transmission of the second control information by the first transport apparatus to the start of the execution of the processing according to the second control information by the second transport apparatus for each of the plurality of second transport apparatuses, based on communication between the first transport apparatus and the plurality of second transport apparatuses; and

identifying a maximum delay time out of the delay times predicted for the plurality of second transport apparatuses, wherein

the standby time for standing by to execute the processing according to the second control information is identified for each of the plurality of second transport apparatuses, based on the maximum delay time.

(Supplementary Note 6)

The transport control method according to any one of supplementary notes 1 to 5, wherein

the first control information includes first transport instruction information for performing transport instruction from the control apparatus to the first transport apparatus, and second transport instruction information for performing transport instruction from the control apparatus to the second transport apparatus.

(Supplementary Note 7)

The transport control method according to supplementary note 6, wherein

the second control information further includes information on the second transport instruction information.

(Supplementary Note 8)

The transport control method according to supplementary note 7, further including:

changing the second transport instruction information transmitted from the control apparatus to the first transport apparatus, based on position information of the second transport apparatus estimated after a predetermined time.

(Supplementary Note 9)

A first transport apparatus including:

a reception processing section configured to receive, from a control apparatus, first control information for transporting an object; and

a transmission processing section configured to transmit, to a second transport apparatus, second control information for cooperating with the second transport apparatus to transport the object according to the first control information.

(Supplementary Note 10)

The first transport apparatus according to supplementary note 9, further including:

a prediction section configured to predict a delay time from transmission of the second control information by the first transport apparatus to start of execution of processing according to the second control information by the second transport apparatus, based on a response from the second transport apparatus in response to the transmission of the second control information; and

a standby processing section configured to stand by to execute processing according to the first control information until the delay time elapses.

(Supplementary Note 11)

The first transport apparatus according to supplementary note 9, further including:

a standby processing section configured to configure a standby time for causing the second transport apparatus to stand by to execute the processing according to the second control information, based on communication with the second transport apparatus, wherein

the transmission processing section is configured to further transmit standby time information on the standby time to the second transport apparatus.

(Supplementary Note 12)

A transport control system including:

a first transmission processing section configured to transmit first control information for transporting an object to a first transport apparatus; and

a second transmission processing section configured to transmit, from the first transport apparatus to a second transport apparatus, second control information for cooperating with the second transport apparatus to transport the object according to the first control information.

(Supplementary Note 13)

The transport control system according to supplementary note 12, further including:

a selection section configured to select the first transport apparatus and the second transport apparatus out of a plurality of transport apparatuses for transporting the object.

(Supplementary Note 14)

The transport control system according to supplementary note 13, wherein

the selection section is configured to select the first transport apparatus and the second transport apparatus, based on received power of a radio signal from a control apparatus to the plurality of transport apparatuses.

(Supplementary Note 15)

The transport control system according to supplementary note 13 or 14, wherein

the selection section is configured to select the first transport apparatus and the second transport apparatus, based on a delay time of communication performed between the plurality of transport apparatuses and the control apparatus.

(Supplementary Note 16)

The transport control system according to any one of supplementary notes 13 to 15, wherein

the selection section is configured to select the first transport apparatus and the second transport apparatus, based on capability information of each of the plurality of transport apparatuses.

(Supplementary Note 17)

The transport control system according to any one of supplementary notes 13 to 16, wherein

the selection section is configured to select the first transport apparatus and the second transport apparatus, based on weight information of the object.

This application claims priority based on JP 2019-179041 filed on Sep. 30, 2019, the entire disclosure of which is incorporated herein.

### INDUSTRIAL APPLICABILITY

Appropriately cooperated operation between transport apparatuses can be enabled when transporting an object using a plurality of transport apparatuses.

### REFERENCE SIGNS LIST

1, 2, 3 Transport Control System
100 Control Apparatus
141 Generation Section
143, 241, 501, 601 Reception Processing Section
145, 151, 243, 503 Transmission Processing Section
147 Selection Section
200, 201, 202, 203 Transport Apparatus
245 Prediction Section
247 Standby Processing Section
249 Drive Control Section
300 Communication Network
400 Transported Object

What is claimed is:

1. A transport control method comprising:
receiving, from a control apparatus, first control information for transporting an object; and
transmitting, from a first transport apparatus to a second transport apparatus, second control information for the first transport apparatus and the second transport apparatus to cooperate to transport the object according to the first control information.

2. The transport control method according to claim 1, further comprising:
predicting a delay time from transmission of the second control information by the first transport apparatus to start of execution of processing according to the second control information by the second transport apparatus, based on a response from the second transport apparatus in response to the transmission of the second control information; and
standing by to execute processing according to the first control information until the delay time elapses.

3. The transport control method according to claim 1, further comprising:
identifying a standby time for causing the second transport apparatus to stand by to execute the processing according to the second control information, based on communication between the first transport apparatus and the second transport apparatus; and
transmitting standby time information on the standby time from the first transport apparatus to the second transport apparatus.

4. The transport control method according to claim 3, wherein
the second transport apparatus is one of a plurality of second transport apparatuses.

5. The transport control method according to claim 4, further comprising:
predicting the delay time from the transmission of the second control information by the first transport apparatus to the start of the execution of the processing according to the second control information by the second transport apparatus for each of the plurality of second transport apparatuses, based on communication between the first transport apparatus and the plurality of second transport apparatuses; and
identifying a maximum delay time out of the delay times predicted for the plurality of second transport apparatuses, wherein
the standby time for standing by to execute the processing according to the second control information is identified for each of the plurality of second transport apparatuses, based on the maximum delay time.

6. The transport control method according to claim 1, wherein
the first control information includes first transport instruction information for performing transport instruction from the control apparatus to the first transport apparatus, and second transport instruction information for performing transport instruction from the control apparatus to the second transport apparatus.

7. The transport control method according to claim 6, wherein
the second control information further includes information on the second transport instruction information.

8. The transport control method according to claim 7, further comprising:
changing the second transport instruction information transmitted from the control apparatus to the first transport apparatus, based on position information of the second transport apparatus estimated after a predetermined time.

9. A first transport apparatus comprising:
a memory storing instructions; and
one or more processors configured to execute the instructions to:
receive, from a control apparatus, first control information for transporting an object; and
transmit, to a second transport apparatus, second control information for cooperating with the second transport apparatus to transport the object according to the first control information.

10. The first transport apparatus according to claim 9, wherein:
the one or more processors are configured to
predict a delay time from transmission of the second control information by the first transport apparatus to start of execution of processing according to the second control information by the second transport apparatus, based on a response from the second transport apparatus in response to the transmission of the second control information; and
stand by to execute processing according to the first control information until the delay time elapses.

11. The first transport apparatus according to claim 9, wherein:
the one or more processors are configured to
configure a standby time for causing the second transport apparatus to stand by to execute the processing according to the second control information, based on communication with the second transport apparatus; and
transmit standby time information on the standby time to the second transport apparatus.

12. A transport control system comprising:
a memory storing instructions; and
one or more processors configured to execute the instructions to:
transmit first control information for transporting an object to a first transport apparatus; and
transmit, from the first transport apparatus to a second transport apparatus, second control information for cooperating with the second transport apparatus to transport the object according to the first control information.

13. The transport control system according to claim 12, wherein:
the one or more processors are configured to select the first transport apparatus and the second transport apparatus out of a plurality of transport apparatuses for transporting the object.

14. The transport control system according to claim 13, wherein
the one or more processors are configured to select the first transport apparatus and the second transport apparatus, based on received power of a radio signal from a control apparatus to the plurality of transport apparatuses.

15. The transport control system according to claim 13, wherein
the one or more processors are configured to select the first transport apparatus and the second transport apparatus, based on a delay time of communication performed between the plurality of transport apparatuses and the control apparatus.

16. The transport control system according to claim 13, wherein
the one or more processors are configured to select the first transport apparatus and the second transport apparatus, based on capability information of each of the plurality of transport apparatuses.

17. The transport control system according to claim 13, wherein
the one or more processors are configured to select the first transport apparatus and the second transport apparatus, based on weight information of the object.
